(19) United States
(12) Patent Application Publication
(10) Pub. No.: US 2017/0153345 A1
(43) Pub. Date: Jun. 1, 2017

(54) PROCESS AND SYSTEM FOR ANALYSIS OF THE SEABED

(71) Applicants: Thibaut CHOQUER, Bayonne (FR); Sébastien DELECRAZ, Bayonne (FR)

(72) Inventors: Thibaut CHOQUER, Bayonne (FR); Sébastien DELECRAZ, Bayonne (FR)

(73) Assignee: KAPPA OFFSHORE SOLUTIONS MARINE OPERATIONS SERVICE (KOSMOS), Bayonne (FR)

(21) Appl. No.: 15/365,121

(22) Filed: Nov. 30, 2016

(30) Foreign Application Priority Data
Nov. 30, 2015 (FR) 15.02488

(51) Int. Cl. G01V 1/38

(52) U.S. Cl. CPC G01V 1/3808; G01V 1/3835; G01V 1/3826; G01V 1/3861

(57) ABSTRACT

A process to analyze the sub-seabed in which: at least one source vessel emits seismic pulses, the reflected seismic pulses are detected, by underwater seismic streamers and towed beside one another, the underwater seismic streamers are geographically located by a geographical location device, the underwater seismic streamers are located with respect to one another by a relative positioning device including acoustic beacons, process wherein towing vessels tow underwater seismic streamers, during their turns, at a depth that differs from one towing vessel to the other so as to enable the underwater seismic streamers to cross over one another.

### BACKGROUND OF THE INVENTION

1. Field of the invention

The technical scope of the present invention is that of systems for the geological analysis by seismic survey of the seabed.

2. Description of the related art

Seismic streamers, also called seismic lines, are acoustic antennas generally towed by a laboratory ship, namely when prospecting for oil. A seismic streamer is formed of an assembly of sections each of several tens of meters in length and each comprising a plurality of seismic sensors as well as their associated electronic components to form a linear acoustic antenna. A laboratory ship generally deploys several seismic streamers each of several kilometers in length. These seismic streamers taken as a whole constitute an array of towed seismic streamers.

A laboratory ship generally tows one or several seismic sources able to generate a source signal suitable for seismic acquisition. A seismic source is constituted, for example, by an array of underwater airguns. The acquisition of geophysical data is made by the sensors of the seismic streamers which are generally is the form of hydrophones. The pressure wave generated by the seismic source passes through the water column to the seabed. This seismic wave is reflected or refracted by the seabed and by the underlying geological structures. The returned wave representative of the geological structure of the seabed may thus be analyzed and utilized.

Seismic exploration campaigns may be programmed over periods of several weeks to several months. The seismic streamers are generally towed at reduced speeds of between 3 to 6 knots. Moreover, the turns which allow two straight acquisition lines to be joined together are long and complex phases that are not generally utilizable for seismic exploration. Indeed, marine seismic surveys involve the analysis of an extended geographical area generally covered by straight travel segments joined by turns. The seismic streamers are positioned side by side to cover an area of the seabed related to the positioning of the seismic source(s).

One technical problems results from the optimization of the surface installations for the efficient coverage of a sub-sea area. Document US-2007/0165486 discloses the association of vessels, each carrying a seismic source, arranged around seismic lines towed by the vessels which also carry a seismic source. The use of multiple sources around the seismic lines enables an optimization of the measurements for the sub-seabed survey and additionally enables analyses of the sub-seabed to be made as the vessels towing the seismic streamers are turning. The fleet requiring many source boats however mobilizes considerable resources both for its implementation and operation.

### SUMMARY OF THE INVENTION

The aim of the present invention is to overcome the drawbacks of prior art by supplying a process as well as a system to survey the sub-seabed namely enabling a reduction in the resources required for its implementation and its operation.

This aim is reached thanks to a process to analyze the sub-seabed in which:

at least one source vessels emits seismic pulses that are reflected by the seabed and the lower layers of the sub-seabed,

the reflected seismic pulses are detected by underwater seismic streamers towed beside one another,

the seismic streamers are geographically located by a geographical location device,

the seismic streamers are located with respect to one another by a relative positioning device comprising acoustic beacons arranged along each seismic streamer,

wherein a plurality of towing vessels, separate from said source vessel, tow at least one of said seismic streamers, the seismic streamers being towed, at least during the turning maneuvers of the towing vessels, at different predetermined depths at least from one towing vessel to another so as to enable at least two seismic streamers towed by separate towing vessels to cross over one another.

According to one particularity of the invention, the straight line analysis phases are made between two turns, the towing vessels being longitudinally staggered one before another according to the order in which they begin to turn, the underwater seismic streamers being towed beside one another thereby being positioned at depths that are staggered from one towing vessel to another at decreasing depths from the first towing vessel beginning to turn, to the last towing vessel beginning to turn.

According to another particularity of the invention, before the turn is made, the seismic streamers towed by one towing vessel are also positioned at tiered depths at increasing or decreasing depths from the streamer to the outermost limit of the turn to the streamer to the innermost limit of the turn.

According to another particularity of the invention, prior to each turn, the towing vessels are staggered longitudinally in steps from the outermost streamer at the turn to the innermost streamer at the turn.

According to another particularity of the invention, prior to each turn, at least the streamer immersed at the shallowest depth is attached to a tail buoy carrying a first geographical locator beacon providing the geographical location of the tailing end of said streamer.

According to another particularity of the invention, the seismic streamers are geographically located at least by the location of a plurality of second geographical locator beacons each arranged in one of the towing vessels.

According to another particularity of the invention, the seismic streamers are geographically located by:

the relative positioning of the acoustic beacons arranged at the tailing ends of the streamers with respect to at least one acoustic beacon carried by at least one locator vessel, separate from the towing vessels, such as the source vessel, and

the geographical location of at least a third geographical locator beacon arranged in said locator vessel.

According to another particularity of the invention, at least two seismic streamers are spaced from one another by at least one hydrofoil intended to cause slight drag and able to be towed by towing vessels each having a gross tonnage of less than 500 UMS.

Another object of the invention relates to a system to analyze the sub-seabed comprising:

at least one source vessel for the emission of seismic pulses reflected by the seabed and the lower layers of the sub-seabed,

a plurality of underwater seismic streamers towed beside one another to receive the reflected seismic pulses,

a geographical device to locate the seismic streamers and

a relative positioning device comprising a plurality of acoustic beacons to locate the seismic streamers with respect to one another, the acoustic beacons being arranged along each seismic streamer,

wherein it comprises a plurality of towing vessels, separate from said source vessel, tow at least one of said seismic streamers, each towing vessel comprising a control element for the depth of said towed streamer arranged so as to set at least one predetermined depth that is different from one towing vessel to another at least during the turning operations of the towing vessels so as to enable at least two seismic streamers towed by separate towing vessels to cross over one another.

According to another particularity of the invention, each towing vessel tows at least two seismic streamers spaced from one another by at least one hydrofoil intended to cause slight drag and be able to be towed by towing vessels each having gross tonnage of less than 500 UMS.

According to another particularity of the invention, said depth control element is arranged so as to set at tiered depths said two seismic streamers towed by the same towing vessel, at least during the turning operations of the towing vessels, the streamers being set at tiered increasing or decreasing depths from the outermost limit of the turn to the streamer to the innermost limit of the turn.

According to another particularity of the invention, one of the streamers is attached to a tail buoy carrying a first geographical locator beacon, the depth of this streamer being set at its shallowest during the turns.

According to another particularity of the invention, the geographical location device comprises a plurality of second geographical locator beacons each arranged in one of the towing vessels.

According to another particularity of the invention, the geographical location device comprises a third beacon to geographically locate at least one tailing end of one of the seismic streamers, this third beacon being arranged in a locator vessel separate from the towing vessels, such as the source vessel, the locator vessel comprising an acoustic beacon for the relative poisoning of the tailing ends of the seismic streamers each equipped at its tailing end with one of the acoustic beacons.

A first advantage lies in that the turning phase, which is not utilized for the survey, is reduced to a minimum, thereby gaining time.

Another advantage of the present invention lies in the fact that towing vessels of low tonnage, even below 500 UMS, may be chosen thereby reducing the cost and improving maneuverability, further reducing the turning phases.

Another advantage of the present invention lies in that it enables numerous configurations with one or several source vessels or a variable number of seismic streamers according to different acquisition geometries thereby enabling a wide variety of analyses to be made.

Thus, the great variety of acquisition geometries enables the use of a large number of streamers.

### BRIEF DESCRIPTION OF THE DRAWINGS

Other characteristics, advantages and particulars of the invention will be better understood from the additional description given hereafter of the embodiments given by way of example with reference to the drawings, in which:

FIG. 1 shows a vessel towing two seismic streamers each equipped with a tail buoy;

FIG. 2 shows a side view of the towing vessel in FIG. 1;

FIG. 3 shows a vessel towing two seismic streamers at a predetermined depth;

FIG. 4 shows a side view of the towing vessel in FIG. 3;

FIG. 5 shows one example of the organ to control the depth of a seismic streamer;

FIG. 6 shows one example of an organ to control the depth and the lateral position of a seismic streamer;

FIGS. 7 and 8 both show one example of a hydrofoil enabling the lateral staggering of the seismic streamers;

FIG. 9 shows one example of a buoy arranged at the tailing end of a seismic streamers and carrying an acoustic positioning beacon as well as a geographical positioning beacon;

FIGS. 10 and 11 each show one example of an acoustic positioning beacon;

FIGS. 12 to 15 and 12b is show example configurations for the sub-seabed analysis phases;

FIGS. 16a, 16b and 16c show an example positioning of the streamers before a turn respectively from a top view, a rear view and a profile view;

FIGS. 17a, 17b and 17c show another example of the positioning of the streamers before a turn respectively from a top view, a rear view and a profile view;

FIGS. 18a, 18b and 18c show another example of the positioning of the streamers before another turn respectively from a top view, a rear view and a profile view;

FIGS. 19a, 19b and 19c show another example of the positioning of the streamers before another turn respectively from a top view, a rear view and a profile view;

FIGS. 20 to 26 show different turning patterns according to the invention; and

FIG. 27 shows one example of a process according to the invention.

### DETAILED DESCRIPTION OF PREFERRED EMBODIMENTS

The invention will now be described in greater detail. The processes to analyze the sub-seabed comprise, in a known manner, the following steps:

the emission of seismic pulses by one or several source vessels, these waves being reflected by the seabed and the sub-seabed,

the detection of the reflected seismic pulses by an array of underwater seismic streamers towed beside one another,

the geographical location of the seismic streamers, that is to say according to a land reference, for example by a satellite positioning system, as well as

the relative location of the seismic streamers with respect to one another thanks to a system of acoustic beacons arranged underwater along each seismic streamer.

The data detected and processed by the seismic streamers according to their position as well as the position of the seismic source(s) thus enables cartography of the sub-seabed to be established. When the seismic streamers are towed by several vessels, the data collected by each vessel is retransmitted by radio waves to a laboratory vessel centralizing all the data enabling the cartography of the sub-seabed to be established.

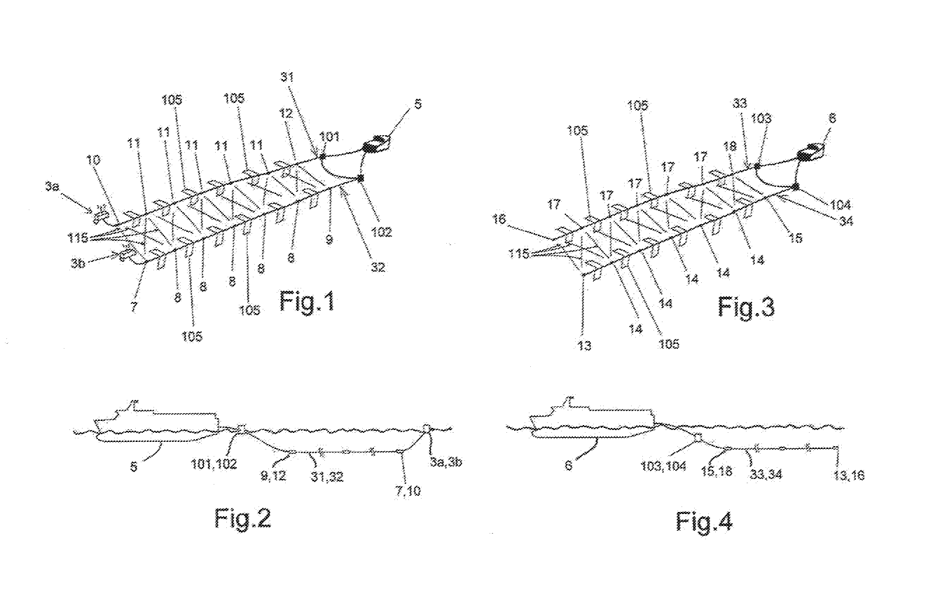

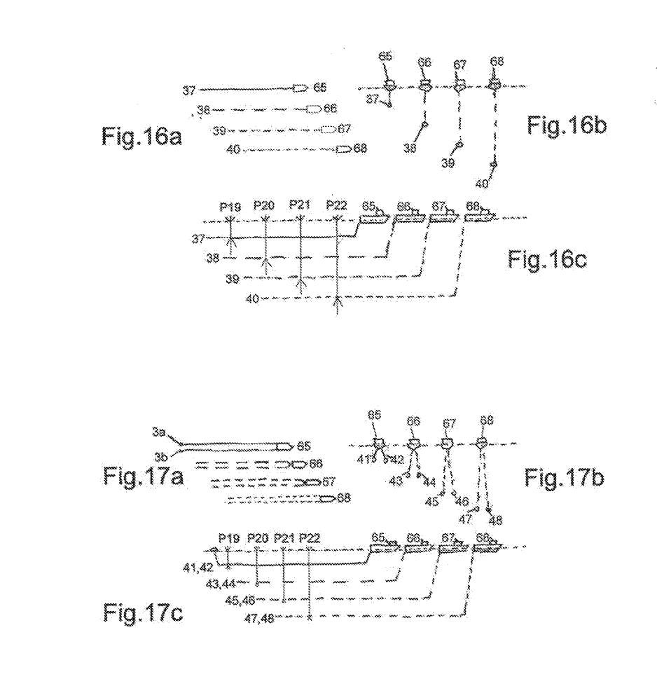

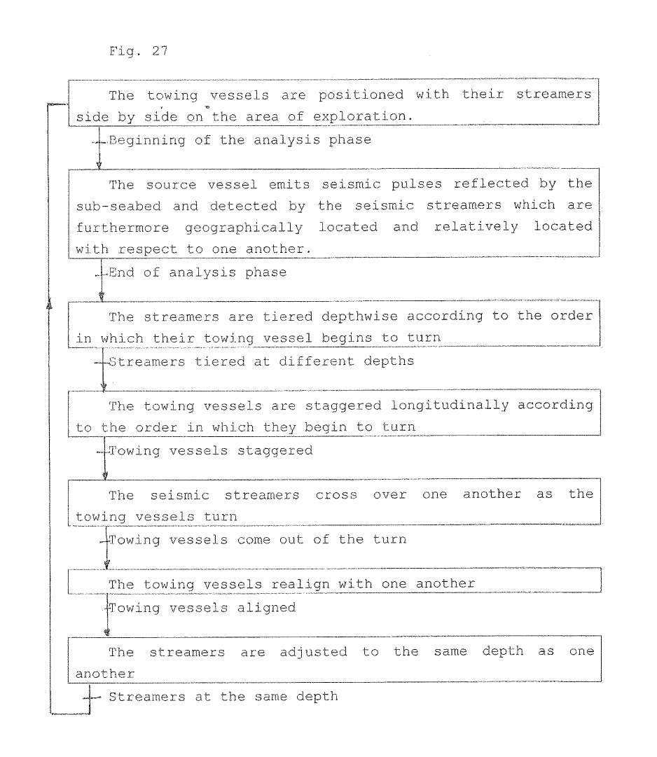

The present invention enables the optimization of the necessary resources thanks to a configuration of the different vessels and an arrangement of the seismic streamers that permit turns to be optimized. One example of the process according to the invention is given in FIG. 27. Examples of means implemented are shown in FIGS. 1 to 15. Examples of different configurations implemented and their use at sea are shown in FIGS. 16a to 26.

FIG. 1 shows a vessel 5 towing two seismic streamers 31 and 32 each equipped with a tail buoy 3a or 3b, this same vessel being shown from the side in FIG. 2. The vessel 5 tows two seismic streamers 31 and 32, which are part of an array of streamers. The assembly formed of the array of seismic streamers and the vessels towing them will be described later.

The two streamers are spaced from one another by hydrofoils 101 and 102. Relative acoustic positioning beacons 7, 8, 9, 10, 11 and 12 are arranged along each streamer. Beacons 9 and 12 are namely positioned at the head and beacons 7 and 10 at the tailing end. The acoustic beacons are evenly positioned along each seismic streamer. The underwater beacons thus emit and receive the sound waves in the water enabling their relative positioning, the relative positioning sound waves 115 being schematized in the form of fine lines drawn between streamers 31 and 32.

A buoy 3a or 3b is attached at the tailing end of each streamer. Each buoy enables a geographical positioning. Each buoy also comprises a relative acoustic positioning beacon, in communication with the other acoustic beacons.

The number of streamers is not restricted. Each towing vessel may, for example, tow a single seismic streamer. Each towing vessel may also tow three seismic streamers or an even greater number of seismic streamers.

The hydrophones, acoustic beacons and buoys, in communication with a control unit of the towing vessel 5, communicate all the data representative of the signals received to this control unit.

The control unit also transmits the positioning set points to adjust the depth of each streamer and potentially its lateral positioning. Depth positioning organs 105 are evenly arranged to this end along each seismic streamer. These depth positioning organs 105 are thus in communication with the control unit of the towing vessel. The positioning organs receive a depth set point and potentially also a lateral offset point and furthermore transmit in real time measurements representative of their depth and potentially their lateral position.

The data received by the towing vessel is, for example, transmitted to a laboratory vessel that collates all the data from each of the towing vessels.

FIG. 3 shows a vessel 6 towing two seismic streamers 33 and 34 at a predetermined depth, this vessel 6 being shown from the side in FIG. 4. There again the vessel 6 tows two seismic streamers 33 and 34 forming part of the streamer array. The two streamers are spaced from one another by hydrofoils 103 and 104.

There again the relative acoustic positioning beacons 13, 14, 15, 16 17 and 18 are arranged along each streamer 33 and 34. Beacons 15 and 18 are namely arranged at the head and beacons 13 and 16 at the tailing end. The acoustic beacons are evenly arranged along each seismic streamer. The beacons thus emit and receive acoustic waves enabling their relative positioning, the relative positioning acoustic waves 115 being schematized in fine lines between streamers 33 and 34.

The streamers are not attached to a tail buoy, their tailing end remaining underwater and free. Each streamer is thus without a tail buoy. The depth of the streamer may advantageously be easily adjusted to different depths, more or less deep, at the tailing end of the seismic streamer which is not attached to a surface element. Crossovers during turns are thus made possible. Furthermore, changes in configuration may be envisaged. The absolute tracking of the seismic streamers will be detailed hereafter.

There again the number of streamers is not restricted. The towing vessel may, for example, tow a single seismic streamer. The towing vessel may also tow three seismic streamers, or an even greater number of seismic streamers.

As for FIG. 1, the hydrophones and the acoustic beacons, in communication with a control unit of the towing vessel 6, communicate all the data representative of the signals received to this control unit. The control unit also transmits positioning set points to adjust the depth of each streamer and potentially its lateral position. Depth positioning organs 10 are evenly arranged to this end along each seismic streamer. These depth positioning organs 105 are, there again, in communication with the control unit of the towing vessel. The data received by the towing vessel is, for example, transmitted to a laboratory vessel that collates the data from each towing vessel.

Several towing vessels towing seismic streamers, such as those described with reference to FIGS. 1 and 3, are used to form a seismic streamer array.

FIG. 5 shows one example of a depth control organ 105a. This organ 105a comprises two maneuverable hydrofoils enabling the depth to be adjusted.

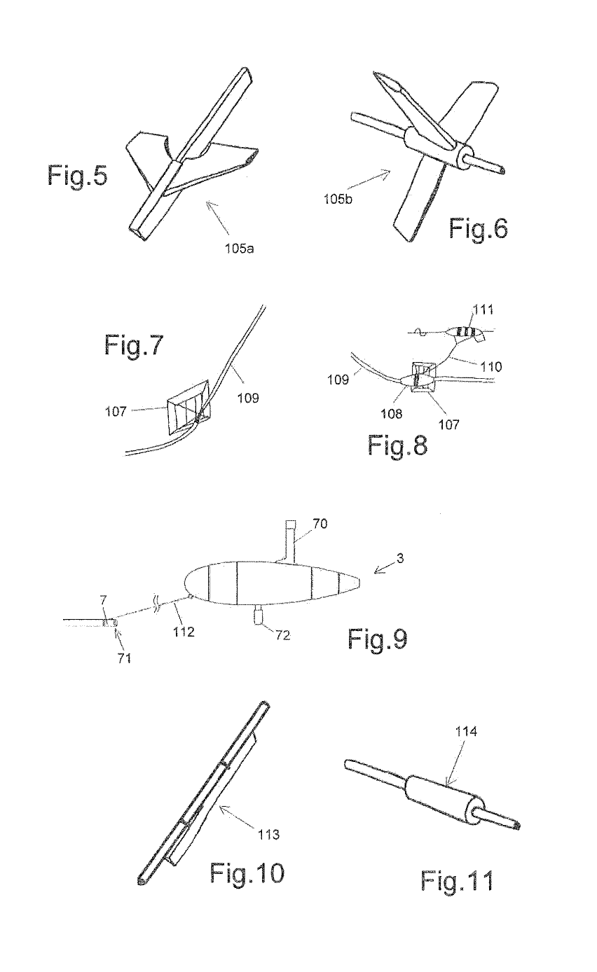

FIG. 6 shows one example of an organ 105b to control the depth and the lateral positioning. This organ 105b comprises three maneuverable hydrofoils enabling the depth and the lateral position to be adjusted.

The streamers may thus each be positioned at a predetermined depth, and potentially laterally, thanks to the depth control organs, known as birds.

FIGS. 7 and 8 each show one example of a hydrofoil enabling the lateral staggering of the seismic streamers, at the streamer head. This may, as shown in FIG. 7, be a panel 107 simply attached to the head of the seismic streamer on the one hand and to an electro-traction cable 109 linked to the towing vessel on the other hand.

FIG. 8 shows another example of a hydrofoil. The deflector panel 107 is attached to a curvature limiter 108 linked upstream of an electro-traction cable 109 itself linked to the towing vessel and downstream to the seismic streamer. The curvature limiter 108 is further linked to a chain 110 linking a buoy 111. The length of the chain 110 enables the depth of the hydrofoil 107 to be adjusted.

The depth of the seismic streamer, downstream of the hydrofoil 107, may additionally be adjusted to a different depth. The depth increases, for example, downstream of the hydrofoil 107 to reach a depth adjusted from the towing vessel.

A hydrofoil, also called deflector, may be used for each streamer. One of the seismic streamers towed by a same towing vessel may also be left without a deflector, this streamer being, in this case, towed in alignment with the towing vessel.

FIG. 9 shows an example of a buoy at the tailing end of the seismic streamer carrying an acoustic positioning beacon 72 and a geographical positioning beacon 70. The buoy 3 is linked by a chain 112 to the tailing end 71 of the seismic streamer. The acoustic beacon 72 of the buoy 3 enables the relative location of the acoustic beacon 7 at the tailing end of the seismic streamer. The data generated by the acoustic beacon 72 and by the geographical positioning beacon 70 will, for example, be transmitted by a cable linked to the seismic streamer or by radio waves directly to the laboratory vessel.

FIGS. 10 and 11 each show an example of an acoustic positioning beacon. The acoustic beacon 114 may be integrated into the structure of the streamer as shown in FIG. 11. It is also possible for the acoustic beacon 113 to be attached to the streamer by clamping rings, the beacon, in this case, being linked to a wireless linking module integrated into the seismic streamer.

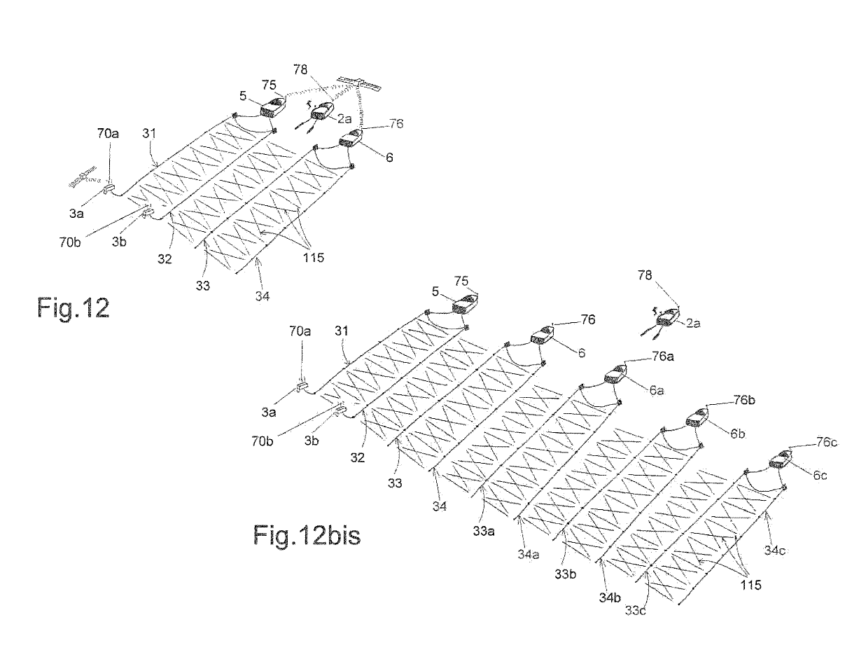

FIGS. 12 to 15 show examples of possible configurations for the sub-seabed analysis phases. Each of these configurations comprises two towing vessels each towing two seismic streamers to form an array of four seismic streamers. The number of seismic streamers in the array and the number of seismic streamers per towing vessel are given by way of example and without limitation.

FIG. 12 shows an array comprising four seismic streamers 31, 32, 33 and 34 towed by two towing vessels 5 and 6. The communications 115 between the acoustic beacons are shown in fine lines. A source vessel 2a is positioned to the fore of the seismic streamers between the towing vessels 5 and 6.

The first towing vessel 5 tows two streamers 31 and 32 each attached to a buoy 3a or 3b at their tailing end. The second towing vessel 6 tows two streamers 33 and 34 whose tailing ends remain underwater and free, that is to say without a buoy. The number of streamers per vessel may also be increased or decreased. One or several other towing vessels 6 with streamers, whose tailing ends remain underwater and free, as shown in FIG. 12b is may also be envisaged. FIG. 12b is shows a configuration with all the elements shown in FIG. 12, the configuration in FIG. 12b is additionally comprising three towing vessels 6a, 6b or respectively 6c each carrying a geographical positioning beacon 76a, 76b or respectively 76c and each towing two seismic streamers 33a and 34b, 33a and 34b or respectively 33c and 34c, whose tailing ends remain underwater and free, that is to say without buoys.

The tail buoys 3a and 3b each comprise a geographical location beacon 70a and 70b enabling the tailing end of these seismic streamers to be precisely located. A single buoy may also be used, the buoy comprising an acoustic beacon enabling the relative positioning of each of the tailing ends.

The towing vessels 5 and 6 also each comprise a geographical location beacon 75 and 76. The source vessel also comprises a geographical location beacon 78.

The geographical location beacons are, for example, satellite location beacons, of the Global Positioning System type.

The streamers tail buoy(s) enable the tailing ends of all the streamers to be precisely geographically positioned whereas the towing vessels also enable a precise geographical location of their front ends. Combining these with the relative positioning enables a precise positioning of the whole of the array and the source(s). The source vessel 2a may also be used to tow one or several streamers. The laboratory vessel is, for example, the source vessel.

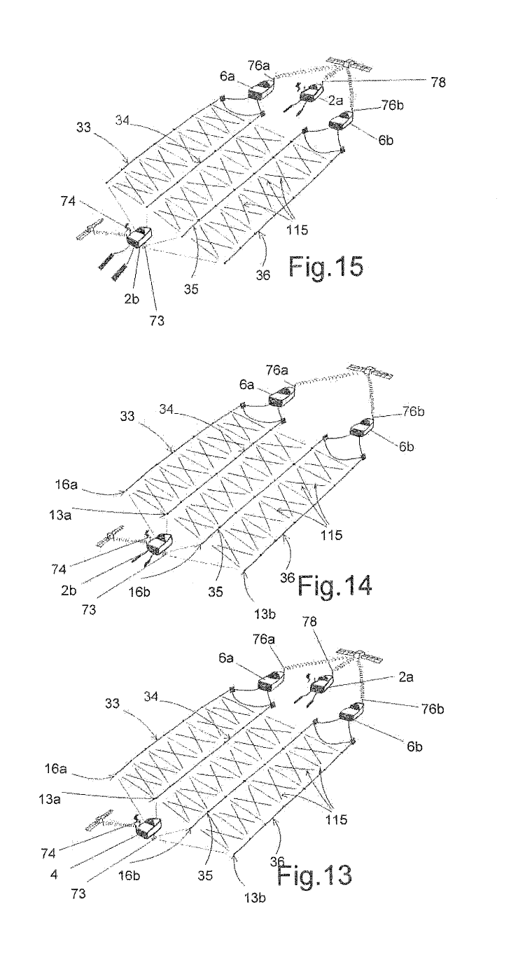

FIG. 13 show an array comprising four seismic streamers 33, 34, 35 and 36 towed by two towing vessels 6a and 6b. The communications 115 between the acoustic beacons are shown in fine lines. A source vessel 2a is positioned to the fore of the seismic streamers between the towing vessels 6a and 6b.

Each towing vessel 6a and 6b tows two streamers 33, 34 and 35, 36 whose tailing ends 13a, 13b 16a and 16b remain underwater and free, that is to say without buoys. One or several other towing vessels may be envisaged. The number of streamers per towing vessel may also be increased or decreased.

A positioning vessel 4 is located to the rear of the array of seismic streamers 33 to 36. This positioning vessel 4 comprises a geographical location beacon 74 and an acoustic beacon 73 enabling a relative positioning of each of the tailing ends 13a, 13b 16a and 16b.

The towing vessels 6a and 6b also each comprise a geographical location beacon 76a and 76b. The source vessel 2a namely also comprises a geographical location beacon 78.

The positioning vessel 4, located to the rear, enables the tailings ends 13a, 13b 16a and 16b of all the streamers to be precisely geographically located whereas the towing vessels 6a and 6b also enable a precise geographical location of their front ends. Combining these with the relative positioning enables a precise positioning of the whole of the array and the source(s). There again, the source vessel 2a may also be used to tow one or several streamers. The laboratory vessel is, for example, the source vessel.

FIG. 14 shows an array comprising four seismic streamers 33, 3 35 and 36 towed by two towing vessels 6a and 6b. The communications 115 between the acoustic beacons are shown in fine lines. A source vessel 2a is positioned to the rear of the seismic streamers.

Each towing vessel 6a and 6b tows two streamers 33, 34 and 35, 36 whose tailing ends remain underwater and free, that is to say without buoys. There again, one or several other towing vessels may be provided. The number of streamers per towing vessel may also be increased or decreased.

The source vessel 2b positioned to the rear of the array of seismic streamers 33 to 36, comprises a geographical location beacon 74 and an acoustic beacon 73 enabling a relative positioning of each of the tailing ends 13a, 13b, 16a and 16b.

The towing vessels 6a and 6b also each comprise a geographical location beacon 76a and 76b.

The source vessel 2b enables the tailing ends 13a, 13b, 16a and 16b of all the streamers to be precisely geographically located whereas the towing vessels 6a and 6b enable a precise geographical location of their front ends. Combining these with the relative positioning enables a precise positioning of the whole of the array and the source(s). There again, the source vessel 2a may also be used to tow one or several streamers. The laboratory vessel is, for example, the source vessel.

FIG. 15 shows an array comprising four seismic streamers 33, 34, 35 and 36 towed by two towing vessels 6a and 6b. The communications 115 between the acoustic beacons are shown in fine lines. A source vessel 2a is positioned to the fore of the seismic streamers between the towing vessels 6a and 6b. Another source vessel 2b is positioned to the rear of the seismic streamers.

There again, each towing vessel 6a and 6b tows two streamers 33, 34, and 35, 36 whose tailing ends remain underwater and free, that is to say without buoys. One or several other towing vessels may also be provided. The number of streamers per towing vessel may also be increased or decreased. The source vessel 2a may also be used to tow one or several streamers.

The source vessel 2b arranged to the rear of the seismic streamers 33 to 36 comprises a geographical location beacon 74 and an acoustic beacon 73 enabling a relative positioning of each of the tailing ends.

The towing vessels 6a and 6b also each comprise a geographical location beacon 76a and 76b. The source vessel 2a to the fore of the seismic streamers also comprises a geographical positioning beacon 78.

The rear source vessel 2b enables the tailing ends of all the streamers to be precisely geographically located whereas the towing vessels 6a and 6b enable a precise geographical location of their front ends. Combining these with relative positioning, there again, enables a precise positioning of the whole array and the sources. The laboratory vessel may be one of the source vessels 2a or 2b.

Thus, the fact of using several towing vessels does not penalize the data acquisition or the positioning accuracy of the seismic streamers. The number of streamers is without limitation. For example, an array of forty streamers may be used towed by twenty towing vessels. An array of thirty seismic streamers may also be used towed by thirty towing vessels or by ten towing vessels. Preferably, one towing vessel will be used to tow two streamers. Streamers may also be towed by a source vessel in the event that the latter is arranged between the towing vessels.

In preparation of a turn, the seismic streamers are positioned at different depths from one towing vessel to another. The deepest streamers are namely without tail buoys. The order in which the vessels begin their turn corresponds to the decreasing depths from one vessel to another. Two vessels cross over the same point one after the other so as to avoid a collision between the vessels or prevent the second vessel from entangling with the start of the seismic streamer on the first vessel which is not yet at the required depth for the crossover. The depth of the seismic streamer thus increases gradually from the towing vessel to reach the specifically pre-set depth for the crossovers. The second towing vessel and its seismic streamer, sufficiently to the rear of the first towing vessel, thus passes over the seismic streamers of the first towing vessel. A same configuration may be used for each of the successive crossovers, a towing vessel being able to pass over several tiered streamers.

The towing vessels are preferably staggered longitudinally behind one another, on either side of the array of streamers, in order to facilitate their turning. The vessels may thus be placed behind one another according to the order in which they start turning.

FIGS. 16a, 16b and 16c show an example of the positioning of the streamers prior to turning respectively from a top view, a rear view and a side view. Each towing vessel 65, 66, 67 or 68 tows a streamer 37, 38, 39 or 40. The foremost vessel 68 tows a streamer 40 at the deepest depth P22, for example 40 m. The second vessel 67, to the rear of the first one 68, tows a streamers 39 at a lesser depth P21, for example 30 m. The third vessel 66, to the rear of the second vessel 67, tows a streamer 38 at a lesser depth P20, for example 20 m. The fourth vessel 65, to the rear of the third one 66, tows a streamer 37 at a lesser depth P19, for example 10 m.

None of the streamers have tail buoys.

The number of vessels as well as the number of streamers per vessel is given by way of example and is without limitation.

The order given to the towing vessels corresponds to their order of passage. The order of passage may also correspond to their positioning prior to making the turn.

FIGS. 17a, 17b and 17c show another example of the positioning of the streamers prior to a turn respectively according to a top view, a rear view and a side view. Each towing vessel 65, 66, 67 or 68 tows two streamers 41 and 42, 43 and 44, 45 and 46 or 47 and 48. The foremost vessel 68 tows two streamers 47 and 48 at the greatest depth P22, for example 40 m. The second vessel 67, to the rear of the first one, tows two streamers 45 and 46 at a lesser depth P21, for example 30 m. The third vessel 66, to the rear with respect to the second vessel 67, tows two streamers 43 and 44 at an even lesser depth, for example 20 m. The fourth vessel 65, to the rear with respect to the third vessel 66, tows two streamers 41 and 42 at a lesser depth P19, for example 10 m. In addition, these two streamers 41 and 42 are each provided with a tail buoy 3a or 3b.

The vessel towing the streamer provided with a tail buoy or towing several streamers each provided with a tail buoy starts to turn last, the depth or depths of its streamers being less than that of the streamers towed by its neighboring vessels. Thus, one or several buoys are associated with the streamers towed by the same vessel, the seismic streamers towed by the other vessels not being provided with tail buoys.

There again, the number of vessels as well as the number of seismic streamers is given by way of example and is without limitation.

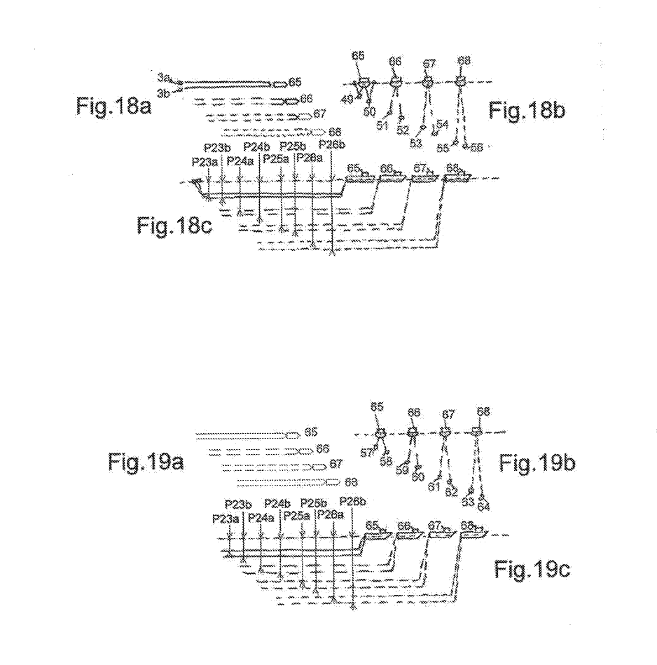

FIGS. 18a, 18b and 18c show another example of the positioning of the streamers prior to a turn respectively according to a top view, a rear view and a side view. Each towing vessel 65, 66, 67 or 68 tows two streamers 49 and 50, 51 and 52, 53 and 54 or 55 and 56. The foremost vessel 68 tows two streamers 55 and 56 at the deepest two depths P26a and P26b, for example 45 m and 40 m. The second vessel 67, to the rear of the first one 68, tows two streamers 3 and 54 at two lesser depths P25a and P25b, for example 35 m and 30 m. The third vessel 66, to the rear of the second one 67, tows two streamers 51 and 52 at two lesser depths P24a and P24b, for example 25 m and 20 m. The fourth vessel 65, to the rear of the third one 66, tows two streamers 49 and 50 at two even lesser depths P23a and P23b, for example 15 m and 10 m. Additionally, these two streamers 49 and 50 are each provided with a tail buoy 3a or 3b.

As shown in FIG. 18b, all the streamers are tiered at increasing depths from streamer 49 to streamer 56. Streamer 49 may be to the inside of the turn and streamer 56 to the outside of the turn. Alternatively, streamer 49 may be to the outside of the turn and streamer 56 to the inside. Example turns will be explained hereafter.

There again, the number of vessels as well as the number of seismic streamers per vessel is given by way of example and is without limitation.

FIGS. 19a, 19b and 19c show another example of the positioning of the streamers prior to a turn respectively according to a top view, a rear view and a side view. Each towing vessel 65, 66, 67 or 68 tows two streamers 57 and 58, 59 and 60, 61 and 62 or 63 and 64. The foremost vessel tows two streamers 63 and 64 at the two deepest depths P26a and P26b the most important, for example 45 m and 40 m. The second vessel 67, to the rear with respect to the first one 68, tows two streamers 61 and 62 at two lesser depths P25a and P25b, for example 35 m and 30 m. The third vessel 66, to the rear with respect to the second vessel 67, tows two streamers 59 and 60 at two lesser depths P24a and P24b, for example 25 m and 20 m. The fourth vessel 65, to the rear with respect to the third one 66, tows two streamers 57 and 58 at two lesser depths P23a and P23b, for example 15 m and 10 m.

As shown in FIG. 19b, all the streamers are tiered at different increasing depths from streamer 57 to streamer 64. Streamer 57 may be to the inside of the turn and streamer 64 to the outside of the turn. Alternatively, streamer 57 may be to the outside of the turn and streamer 64 to the inside.

There again, the number of vessels as well as the number of seismic streamers per vessel is given by way of example and is without limitation.

According to the examples shown in FIGS. 16c, 17c, 18c and 19c, the foremost vessel is the one in which the streamers are set at the greatest depths and it is thus this vessel which starts to turn first. This corresponds to preferred configurations of the invention but the vessels may also be left at the same level, before their crossover, without departing from the scope of the invention. The vessels can also be arranged in a different positioning, the towing vessels starting the turn according to the depths of their streamers, in decreasing order. The vessel towing a streamer provided with a buoy is the last to turn and passes over all the other tiered seismic streamers at the crossover point.

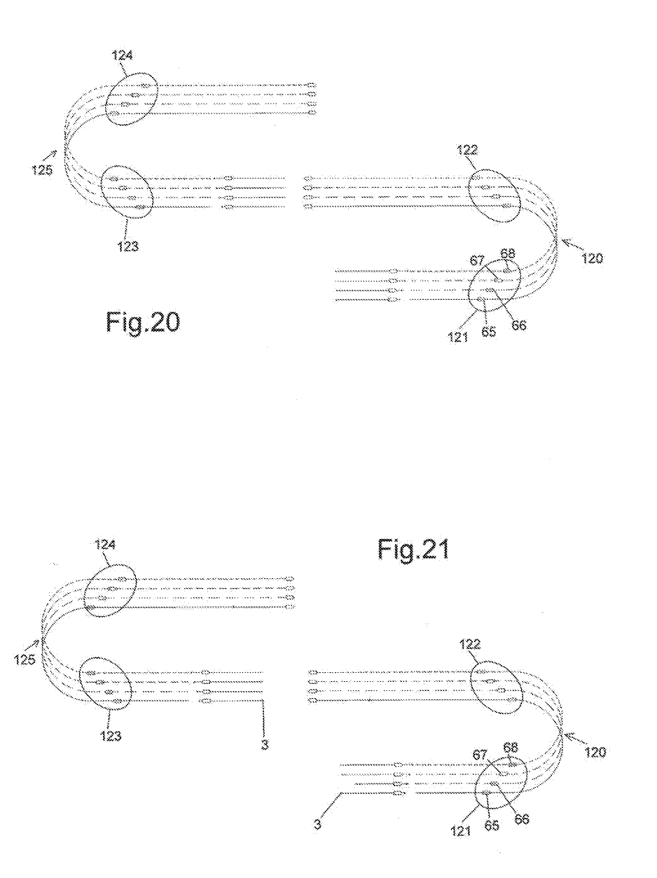

FIGS. 20 to 26 show different turn patterns according to the invention. The streamers towed by towing vessels 65, 66, 67 and 68 may be configured in accordance with the description made with reference to FIGS. 16 to 19. The continuous lines correspond to the trajectories of the streamers at the least depths and the finest dotted lines correspond to the trajectories of the streamers at the greatest depths.

In FIG. 20, the first towing vessel 68 at the greatest depth passes the crossover point 120 first followed by the second towing vessel 67, then the third one 66 and finally the fourth one 65.

In order to simplify the drawings, only the towing vessels and their trajectories are shown. The fleet passes from a configuration 121 with the first towing vessel in the lead to a configuration 122 also with the first towing vessel in the lead. The first towing vessel is systematically on the inside of the turn and ahead of the others prior to each turn.

The streamers are brought back, for example, to the same depth and the towing vessels to the same level before a new analysis phase begins.

The towing vessels are then brought into a configuration 123 with the first towing vessel leading, the streamers being tiered. The towing vessels successively pass the crossover point 125 before taking up configuration 124 as they come out of the turn.

The streamers are brought back, for example, to the same depth and the towing vessels to the same level before a new analysis phase begins.

In each configuration 121, 122, 123 or 124 the same vessel corresponds to the first, the second, the third or the fourth towing vessel.

FIG. 21 shows two turns for a fleet of towing vessels. Configurations 121, 122, 123 and 124 of the towing vessels are the same as those described in FIG. 20 as are the crossover points 120 and 125. One difference stems from the fact that the last towing vessel 65 is provided with one or several buoys on the tailing end(s) of its seismic streamer(s). The vessel associated with the tail buoy is thus the last to pass the crossover point 120 and 125.

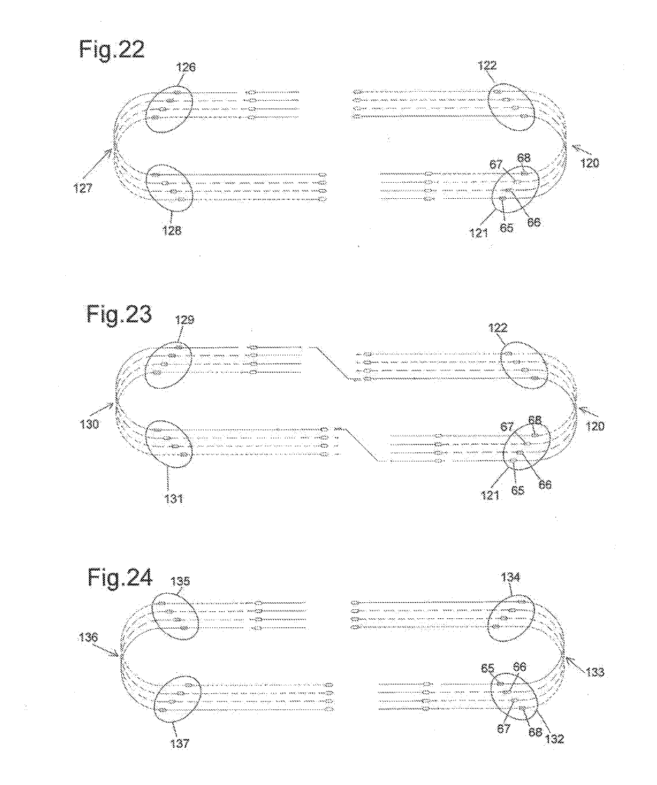

In FIG. 22, the fleet moves from configuration 121 with the first towing vessel leading to configuration 122 also with the first towing vessel leading.

The streamers are brought back, for example, to the same depth and the towing vessels to the same level before a new analysis phase beings.

The first towing vessel is systematically to the inside of the turn but the positions of the vessels are modified prior to each turn. The first and fourth towing vessels are switched and the second and third towing vessels are switched.

The towing vessels are thus brought into configuration 126 with a new first towing vessel in the lead, the streamers being tiered. The towing vessels successively pass the crossover point 127 before taking up configuration 124 as they come out of the turn with the towing vessel in the lead.

The streamers are then brought back, for example, to the same depth and the towing vessels to the same level before a new analysis phase begins.

The first and fourth towing vessels are once again switched and the second and third towing vessels are once again switched to make the following turn.

FIG. 23 shows two turns with the first towing vessel, which is to say the one towing the streamer at the greatest depth, to the inside of the turn. The fourth towing vessel towing one or several buoys is systematically removed to the outside of the turn. Thus, there is a repositioning of the fourth towing vessel and the positions of the second and third towing vessels are switched before each new turn of the fleet.

The fleet moves from configuration 121 with the first towing vessel in the lead to configuration 122 also with the first towing vessel in the lead.

The streamers are brought back, for example, to the same depth and the towing vessels to the same level before a new analysis phase begins.

The fourth towing vessel is positioned to the outside and the depths of the streamers are adjusted in accordance with the order of the towing vessels by switching the first and third towing vessels.

The towing vessels are thus brought into configuration 129 with a first towing vessel in the lead and to the inside of the turn, the streamers being tiered. The towing vessels successively pass the crossover point 130 before taking up configuration 131 as they come out of the turn with the first towing vessel in the lead and to the outside of the turn.

The streamers are then brought back, for example, to the same depth and the towing vessels to the same level before a new analysis phase begins.

The fourth towing vessel is once again offset to the outside of the turn and the positions of the third and first towing vessels are once again switched before the following turn.

In the turns shown in FIG. 24, the first towing vessel is arranged to the outside of the turn and the fourth towing vessel is arranged to the inside.

The fleet moves from configuration 132 with the first towing vessel in the lead to configuration 134 also with the first towing vessel in the lead but on the inside with respect to the next turn.

The streamers are for example conducted at the same depth and the towing vessels at the same level, before beginning the analysis phase.

The first towing vessel is systematically to the outside of the turn but the positions of the vessels are switched prior to each turn. The first and fourth towing vessels are switched and the second and third towing vessels are also switched.

The towing vessels are thus brought into configuration 135 with a new first towing vessel in the lead and to the outside of the turn, the streamers being tiered. The towing vessels successively pass the crossover point 136 before taking up configuration 137 as they come out of the turn.

The streamers are brought back, for example, to the same depth and the towing vessels to the same level before a new analysis phase begins.

The first and fourth towing vessels are switched once again and the second and third towing vessels are switched once again before the following turn.

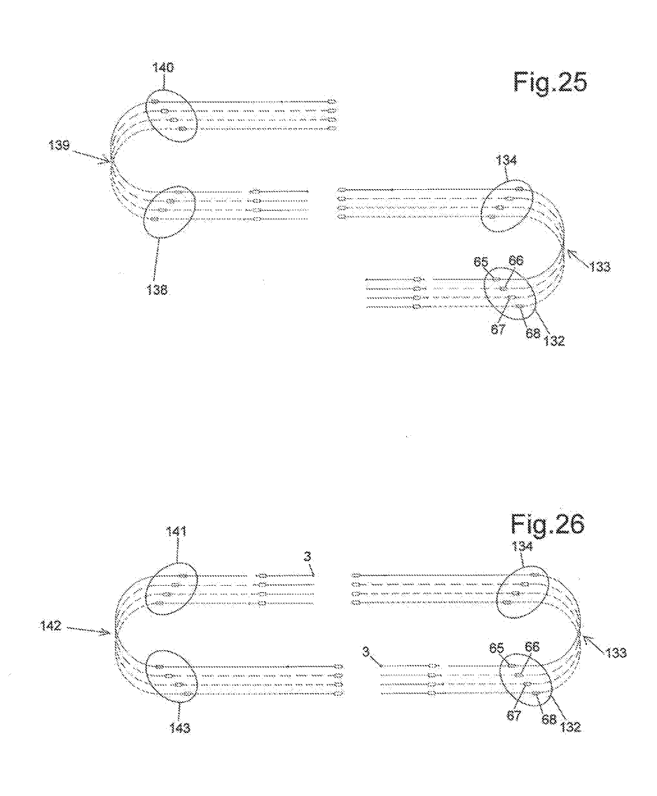

In FIG. 25, the towing vessels retain the same position from one turn to the next, the first towing vessel always being positioned to the outside of the turn.

The fleet moves from configuration 132 with the first towing vessel in the lead and to the outside to configuration 134 also with the first towing vessel in the lead and to the outside with respect to the following turn. The vessels successively pass the crossover point 133.

The streamers are then brought back, for example, to the same depth and the towing vessels to the same level before a new analysis phase begins.

The towing vessels are then brought into configuration 138 with the same first towing vessel in the lead, the streamers being tiered. The towing vessels successively pass the crossover point 139 before taking up configuration 140 as they come out of the turn.

The streamers are then brought back, for example, to the same depth and the towing vessels to the same level before a new analysis phase begins.

FIG. 26 shows two turns where the vessels keep their order of passage for each turn but where the first towing vessel is successively in the lead and to the outside of the turn and then in the lead and to the inside of the turn. The fourth towing vessel tows a tail buoy and is successively to the inside and then the outside of each turn.

The fleet moves from configuration 132 with the first towing vessel in the lead and to the outside to configuration 134 also with the first towing vessel in the lead but to the inside with respect to the next turn. The vessels successively pass the crossover point 133.

The streamers are then brought back, for example, to the same depth and the towing vessels to the same level before a new analysis phase begins.

The towing vessels are then brought into configuration 141 with the same first towing vessel in the lead and to the inside, the streamers being tiered. The towing vessels successively pass the crossover point 142 before taking up configuration 143 as they come out of the turn where the first towing vessel is in the lead and to the outside with respect to the next turn.

The streamers are then brought back, for example, to the same depth and the towing vessels to the same level before a new analysis phase begins.

It should be obvious to a person skilled in the art that the present invention allows other embodiments. Consequently, the present embodiments should be regarded as illustrative of the invention.

What is claimed is:

1. A process to analyze the sub-seabed in which:
at least one source vessel emits seismic pulses that are reflected by the seabed and the lower layers of the sub-seabed,
the reflected seismic pulses are detected, during the analysis phases by a plurality of underwater seismic streamers and towed beside one another,
said underwater seismic streamers are geographically located by a geographical location device,
said underwater seismic streamers are located with respect to one another by a relative positioning device comprising acoustic beacons arranged along each one of said underwater seismic streamers,
wherein a plurality of towing vessels separate from said source vessel, tow at least one of said underwater seismic streamers, said underwater seismic streamers being towed, at least during the turns of said towing vessels, at one predetermined depth (P19 to P22) at least, that is different from one of said towing vessels to the other one so as to enable at least two of said underwater seismic streamers, towed by separate said towing vessels, to cross over one another.

2. Process to analyze the sub-seabed according to claim 1, wherein the straight line analysis phases are made between two turns, said towing vessels being longitudinally staggered one before another according to the order in which they begin to turn, prior to each turn, said underwater seismic streamers being towed beside one another then being positioned at depths (P19, P20, P21, P22) that are tiered from one of said towing vessels to another at decreasing depths from the first of said towing vessels beginning to turn, to the last of said towing vessels beginning to turn.

3. Process to analyze the sub-seabed according to claim 2, wherein prior to each turn, said underwater seismic streamers towed by one of said towing vessels are also positioned at tiered depths (P23a, P23b, P24a, P24b, P25a, P25b, P26a, P26b) at increasing or decreasing depths from one of underwater seismic streamers to the outermost limit of the turn to said first of said underwater seismic streamers to the innermost limit of the turn.

4. Process to analyze the sub-seabed according to claim 3, wherein prior to each turn, said towing vessels are staggered longitudinally in steps from said outermost of said underwater seismic streamers at the turn to the innermost of said underwater seismic streamers at the turn.

5. Process to analyze the sub-seabed according to claim 2, wherein prior to each turn, at least the underwater seismic streamer of said underwater seismic streamers immersed at the shallowest depth is attached to a tail buoy carrying a first geographical locator beacon providing the geographical location of the tailing end of said underwater seismic streamer.

6. Process to analyze the sub-seabed according to claim 1, wherein said underwater seismic streamers are geographically located at least by the location of a plurality of second geographical locator beacons each arranged in one of said towing vessels.

7. Process to analyze the sub-seabed according to claim 6, wherein said underwater seismic streamers are geographically located by:
the relative positioning of said acoustic beacons arranged at the tailing ends of said underwater seismic streamers with respect to at least one of said acoustic beacons carried by at least one locator vessel, separate from said towing vessels, such as said source vessel, and
the geographical location of at least a third geographical locator beacon arranged in said locator vessel.

8. Process to analyze the sub-seabed according to claim 7, wherein at least two of said underwater seismic streamers are spaced from one another by at least one hydrofoil intended to cause slight drag and able to be towed by said towing vessels each having a gross tonnage of less than 500 UMS.

9. A system to analyze the sub-seabed comprising:
at least one source vessel for the emission of seismic pulses reflected by the seabed and the lower layers of the sub-seabed,
a plurality of underwater seismic streamers towed beside one another to receive the reflected seismic pulses,
a geographical device to locate said underwater seismic streamers and
a relative positioning device comprising a plurality of acoustic beacons to locate said underwater seismic streamers with respect to one another, said acoustic beacons being arranged along each of said underwater seismic streamers,
wherein it comprises a plurality of towing vessels, separate from said source vessel, tow at least one of said underwater seismic streamers, each of said towing vessels comprising a control element for the depth of said one of towed underwater seismic streamers arranged so as to set at least one predetermined depth (P19 to P22) that is different from one of said towing vessel to another at least during the turning operations of said towing vessels so as to enable at least two of said underwater seismic streamers towed by separate said towing vessels to cross over one another.

10. A system to analyze the sub-seabed according to claim 9, wherein each of said towing vessel tows at least two of said underwater seismic streamers spaced from one another by at least one hydrofoil intended to cause slight drag and be able to be towed by said towing vessels each having gross tonnage of less than 500 UMS.

11. A system to analyze the sub-seabed according to claim 10, wherein said depth control element is arranged so as to set at tiered depths said two of said underwater seismic streamers towed by the same towing vessel, at least during the turning operations of said towing vessels, said underwater seismic streamers being set at tiered increasing or decreasing depths (P23a, P23b, P24a, P24b, P25a, P25b) from the outermost limit of the turn to the underwater seismic streamer to the innermost limit of the turn.

12. A system to analyze the sub-seabed according to claim 9, wherein at least one of said underwater seismic streamers is attached to a tail buoy carrying a first geographical locator beacon, the depth of said one of said underwater seismic streamers being set at its shallowest during the turns.

13. A system to analyze the sub-seabed according to claim 12, wherein said geographical location device comprises a plurality of second geographical locator beacons each arranged in one of the towing vessels.

14. A system to analyze the sub-seabed according to claim 9, wherein said geographical location device comprises a third beacon to geographically locate at least one tailing end of one of said underwater seismic streamers, said third beacon being arranged in a locator vessel separate from said towing vessels, such as said source vessel, said locator vessel comprising an acoustic beacon for the relative positioning of the tailing ends of said underwater seismic streamers each equipped at its tailing end with one of said acoustic beacons.
